(19) United States
(12) Patent Application Publication
(10) Pub. No.: US 2026/0120520 A1
(43) Pub. Date: Apr. 30, 2026

(54) EARLY NOTIFICATION SYSTEM FOR TIRE CHANGES IN VEHICLES

(71) Applicant: Volvo Car Corporation, Göteborg (SE)

(72) Inventors: Ehsan Yasari, Gothenburg (SE); András Bálint, Gothenburg (SE)

(21) Appl. No.: 18/931,176

(22) Filed: Oct. 30, 2024

(51) Int. Cl. G07C 5/00; G06Q 10/1093; G07C 5/10

(52) U.S. Cl. CPC G07C 5/006; G07C 5/10; G06Q 10/1093

(57) ABSTRACT

One or more systems, computer-implemented method and/or computer program products provided herein relate to an early notification system that can predict, based on local tire-related regulations and weather conditions related to a geographic location of a vehicle as well as other factors, when the vehicle is due for a tire change service. For example, a system can comprise a memory that can store computer executable components. The system can further comprise a processor that can execute the computer executable components stored in the memory. The computer executable components can comprise a data collection component that can collect location data, tire requirements data and tire characterization data for a vehicle. The computer executable components can further comprise a data analysis component that can determine, by analyzing the location data and the tire requirements data against the tire characterization data, whether one or more tires of the vehicle are to be changed.

### TECHNICAL FIELD

The subject disclosure relates to vehicular systems and, more specifically, to an early notification system that can predict when tire changes are due for vehicles.

### BACKGROUND

The transition from summer tires to winter tires and vice versa is a crucial aspect of vehicle maintenance that often poses challenges for drivers and vehicle owners. One of the most common issues is the forgetfulness of individuals. For example, many drivers simply forget to change the tires of their vehicles until the last minute. Such delays can often lead to a rush at tire workshops (e.g., auto shops, garages, repair shops, service centers, auto repair facilities, etc.) for tire change services, resulting in long queues and extended waiting times that not only disrupt the drivers' schedules, but also put a strain on the workshops as they can become overwhelmed with work. Another challenge is the unpredictability of weather conditions. For example, early snowfall can catch drivers off guard, leaving their vehicles with summer tires in winter conditions. This can be particularly dangerous as summer tires do not provide a good grip on the surface of a road in snowy or icy conditions, thereby increasing the risk of accidents.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable an early notification system that can predict when a vehicle is due for a tire change service are discussed.

According to an embodiment, a system is provided. The system can comprise a memory that can store computer executable components. The system can further comprise a processor that can execute the computer executable components stored in the memory, where the computer executable components can comprise a data collection component that can collect location data, tire requirements data and tire characterization data for a vehicle. The computer executable components can further comprise a data analysis component that can determine, by analyzing the location data and the tire requirements data against the tire characterization data, whether one or more tires of the vehicle are to be changed.

According to another embodiment, a computer-implemented method is provided. The computer-implemented method can comprise collecting, by a system operatively coupled to a processor, location data, tire requirements data and tire characterization data for a vehicle. The computer-implemented method can further comprise determining, by the system, by analyzing the location data and the tire requirements data against the tire characterization data, whether one or more tires of the vehicle are to be changed.

According to yet another embodiment, a computer program product is provided. The computer program product can comprise a computer readable storage medium having program instructions embodied therewith, the program instructions executable by a processor to cause the processor to collect, by the processor, location data, tire requirements data and tire characterization data for a vehicle. The program instructions can be further executable by the processor to cause the processor to determine, by the processor, by analyzing the location data and the tire requirements data against the tire characterization data, whether one or more tires of the vehicle are to be changed.

### BRIEF DESCRIPTION OF THE DRAWINGS

One or more embodiments are described below in the Detailed Description section with reference to the following drawings:

FIG. 1 illustrates a block diagram of an example, non-limiting system that can detect, based on weather conditions, regional regulations and a current state of tires of a vehicle, whether the tires of the vehicle are due for a change, in accordance with one or more embodiments described herein.

FIG. 2 illustrates another block diagram of an example, non-limiting system that can detect, based on weather conditions, regional regulations and a current state of tires of a vehicle, whether the tires of the vehicle are due for a change, in accordance with one or more embodiments described herein.

FIG. 3 illustrates a diagram of an example, non-limiting system that can detect, based on weather conditions, regional regulations and a current state of tires of a vehicle, whether the tires of the vehicle are due for a change, in accordance with one or more embodiments described herein.

FIG. 4 illustrates a flow diagram of an example, non-limiting method that can detect, based on weather conditions, regional regulations and a current state of tires of a vehicle, whether the tires of the vehicle are due for a change, in accordance with one or more embodiments described herein.

FIG. 5 illustrates an example, non-limiting flow diagram of modules that can detect, based on weather conditions, regional regulations and a current state of tires of a vehicle, whether the tires of the vehicle are due for a change, in accordance with one or more embodiments described herein.

FIG. 6 illustrates a flow diagram of an example, non-limiting method that can be employed to schedule a tire change service, in accordance with one or more embodiments described herein.

FIG. 7 illustrates a diagram of an example, non-limiting system that can employ cloud-based quantum computing to determine whether the tires of a vehicle are due for a change, in accordance with one or more embodiments described herein.

FIG. 8 illustrates a flow diagram of an example, non-limiting method that can detect, based on weather conditions, regional regulations and a current state of tires of a vehicle, whether the tires of the vehicle are due for a change, in accordance with one or more embodiments described herein.

FIG. 9 depicts an example schematic block diagram of a computing environment with which the disclosed subject matter can interact at least in part, in accordance with various aspects and implementations of the subject disclosure.

FIG. 10 is a block diagram representing an example computing environment into which aspects of the subject matter described herein may be incorporated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

The transition from summer tires to winter tires and vice versa is a crucial aspect of vehicle maintenance that often poses challenges for drivers and vehicle owners. One of the most common issues is the forgetfulness of individuals. For example, many drivers simply forget to change the tires of their vehicles until the last minute. Such delays can often lead to a rush at tire workshops (e.g., auto shops, garages, repair shops, service centers, auto repair facilities, auto dealership services etc.) for tire change services, resulting in long queues and extended waiting times that not only disrupt the drivers' schedules, but also put a strain on the workshops as they can become overwhelmed with work. Another challenge is the unpredictability of weather conditions. For example, early snowfall can catch drivers off guard, leaving their vehicles with summer tires in winter conditions. This can be particularly dangerous as summer tires do not provide a good grip on the surface of a road in snowy or icy conditions, thereby increasing the risk of accidents. Moreover, the regulations regarding winter tires often vary significantly from country to country. For example, some countries have specific time periods during which winter tires are mandatory. For example, in Sweden, winter tires are typically mandatory between December 1^{st} of a given year and March 31^{st} of the subsequent year, whereas in Slovenia, winter tires are mandatory between November 15^{th} of a given year and March 15^{th} of the subsequent year. In some other countries such as Austria, Finland and Germany, regulations for winter tires are based on existing weather conditions. Further, some countries including Spain, France and Italy, impose such limitations only on specific roads and at specific times of the year. The inconsistency in regulations of different countries can be particularly challenging for individuals who travel to different countries during the winter months. In scenarios where winter tires are not mandatory, tire tread, tread depth, tire type, etc. can play a significant role. For example, in snowy weather, the type of tires (e.g., summer tires) can play a significant role in determining whether a vehicle's tires should be changed.

The challenge of remembering different regulations and the time to change winter/summer tires is well-known, and drivers need to be aware of regional regulations related to tires. Some common and reliable methods adopted by drivers to ensure that vehicle tires are changed in due time include setting reminders on calendars, booking/reserving time slots at workshops for tire change services well in advance, based on prior experience with queues, thereby avoiding queues at the workshops, or manually checking the news and weather forecasts to ensure, for example, that summer tires are swapped with winter tires ahead of the winter weather conditions. However, such methods largely rely on memory, and forgetfulness can creep in, even if one hears on the news that, for example, cold climate or severe weather is approaching. In many cases, individuals tend to forget the timing of a scheduled tire change service, and in some cases, individuals may not even be aware of regulations pertaining to the type of tires. Thus, a more efficient and automated approach to address tire changes in vehicles is desirable.

Various embodiments of the present disclosure can be implemented to produce a solution to these problems. Embodiments described herein include systems, computer-implemented methods, and computer program products that can provide an early notification system that can predict when tire changes in vehicles are due. In various embodiments, the early notification system can notify an operator about the need to change the tires on their vehicle. It should be appreciated that in the various embodiments disclosed throughout this specification, the operator can be a hardware, a software, a machine, an artificial intelligence (AI), a neural network and/or a user. For example, the early notification system can notify a human driver of a manually operated vehicle or an AI system or neural network of an autonomous vehicle that their vehicle is due for a tire change service. The tire change service can involve replacing summer tires with winter tires, replacing worn out tires with new tires, and so on. In various embodiments, the early notification system can evaluate various factors such as weather forecasts, news, tire-related regional laws and regulations, tire-related road regulations that apply only to specific roads, tire tread, tread depth, and so on, to assess whether the tires on the vehicle need to be changed. If so, a notification for the same can be displayed to the operator of the vehicle. In one or more embodiments, if the early notification system determines that the tires are to be replaced, the early notification system can generate a recommendation for scheduling a workshop visit for a tire change service, based on the available dates, costs, preset personal preferences of the operator or owner of the vehicle, etc. In one or more embodiments, the early notification system can automatically schedule a workshop visit by analyzing the relevant factors. As previously stated, individuals that travel through regions with different respective regionals laws and regulations, weather conditions, etc. can find it challenging to familiarize themselves with all the relevant regulations of each region, weather forecasts, etc. In various embodiments, the early notification system can address such scenarios by determining a tire type that is the safest for all the regions that a vehicle can be expected to be driven to. That is, the early notifications system can make conservative predictions based on the situation. In various embodiments, the early notification system can be a fully automated system that can be embedded within a vehicle and that can make predictions without involving manual tire checks by a mechanic or by a driver of the vehicle, and without relying on the driver's knowledge of regional regulations.

More specifically, in one or more embodiments, the early notification system can comprise an early notification model that can employ the internal and/or external sensors within a vehicle to determine the tire tread, tread depth, tire width, aspect ratio, speed rating, sidewall, rim diameter, overall diameter, tire pressure, tire type (e.g., winter tires, summer tires, all season tires), and other parameters related to the tires of the vehicle. Additionally, in one or more embodiments, the early notification system can collect GPS data of the vehicle and access a database comprising information about regional laws and regulations to determine a current geographic location of the vehicle, geographic locations where the vehicle is expected to be driven to/visit at a future time (i.e., one or more future geographic locations), regional laws and regulations related to the current and future geographic locations, and other pertinent details. The early notification model can employ the information thus collected to determine, via AI models and/or rule-based software, whether the tires of the vehicle are to be changed. If so, the early notification model can inform the operator or owner of the vehicle, in advance, about the date by which the tires should be changed or the time period within which the tires should be changed. In cases where winter tires are only required on specific roads, the early notification model can employ a GPS device on-board the vehicle to check whether the vehicle is in the vicinity of such roads and proactively warn the operator of the vehicle about the roads. In some scenarios, early notification model can potentially display the roads and areas with specific regulations on a map, wherein the map can be presented to the operator on a screen of the vehicle to assist the operator to determine whether the tires are to be changed. The early notification system can also employ information about upcoming or pre-planned trips to identify roads with specific tire-related regulations and restrictions. In addition, the early notification model can employ weather forecasting data to inform the operator in advance about weather conditions (e.g., early snowfall, cold climates, unexpected or unusually early snow/ice/cold temperatures, etc.) for which the vehicle will need different tires. In various embodiments, the early notification model can be deployed in the vehicle as a built-in feature that can also generate reminders to remind the operator that a tire change is due for the vehicle.

Embodiments of the present disclosure can improve a vehicle driving experience and vehicle safety by proactively ensuring that a vehicle has the most suitable type of tires, that is, tires that are safe and compliant with tire-related regional laws and regulations and tire-related road regulations, at all times. Additionally, embodiments of the present disclosure can reduce or eliminate the manual involvement of an operator/owner/maintenance personnel associated with the vehicle in tracking tire-related issues, thereby reducing the burden related to overall vehicle maintenance. Finally, the tire change process for a vehicle can be smoother because the last-minute customer rush at a workshop for tire change services can be more uniformly distributed.

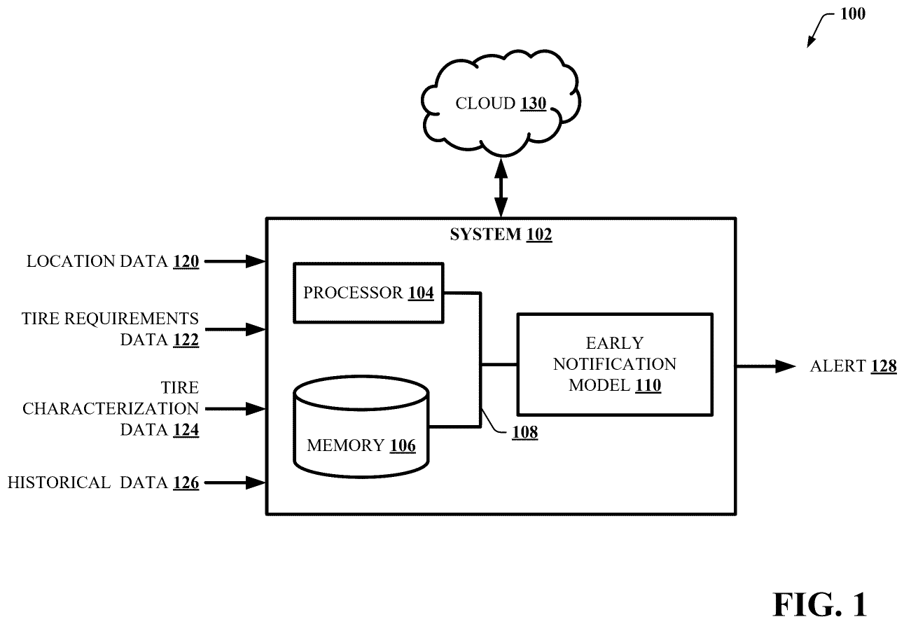

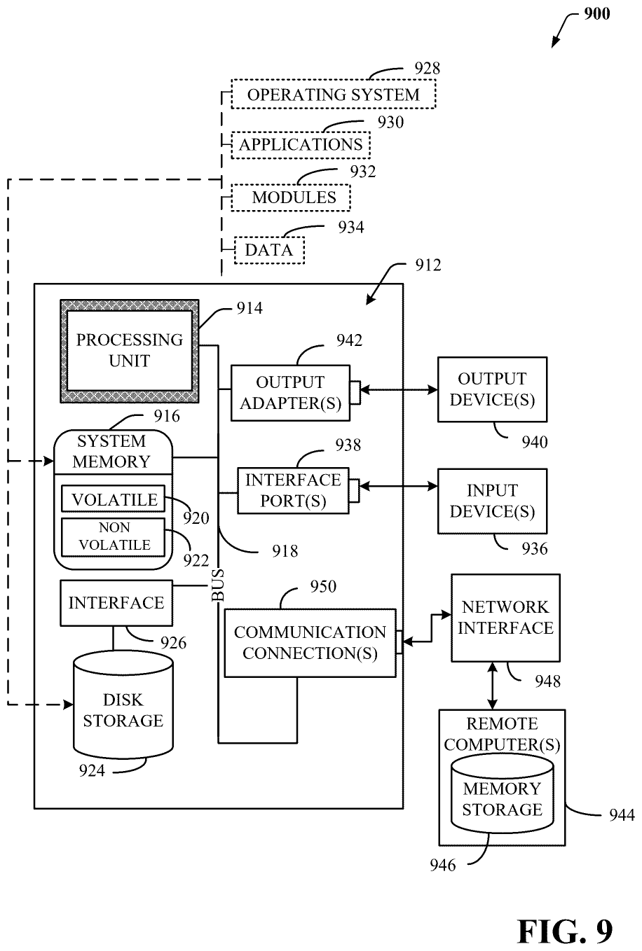

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 900 illustrated at FIG. 9. For example, non-limiting system 100 can be associated with, such as accessible via, a computing environment 900 described below with reference to FIG. 9, such that aspects of processing can be distributed between non-limiting system 100 and the computing environment 900. In one or more described embodiments, computer and/or computing-based elements can be used in connection with implementing one or more of the systems, devices, components and/or computer-implemented operations shown and/or described in connection with FIG. 1 and/or with other figures described herein.

For simplicity of explanation, the computer-implemented and non-computer-implemented methodologies provided herein are depicted and/or described as a series of acts. It is to be understood that the subject innovation is not limited by the acts illustrated and/or by the order of acts. For example, acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

FIG. 1 illustrates a block diagram of an example, non-limiting system 100 that can detect, based on weather conditions, regional regulations and a current state of tires of a vehicle, whether the tires of the vehicle are due for a change, in accordance with one or more embodiments described herein.

Non-limiting system 100 and/or the components of non-limiting system 100 can be employed to use hardware and/or software to solve problems that are highly technical in nature (e.g., related to AI, machine learning, automated predictions, etc.), that are not abstract and that cannot be performed as a set of mental acts by a human. Further, some of the processes performed may be performed by specialized computers for carrying out defined tasks related to early notification system that can predict when the tires of a vehicle are due for a change. Non-limiting system 100 and/or components of non-limiting system 100 can be employed to solve new problems that arise through advancements in technologies mentioned above, vehicular systems, and/or the like. Non-limiting system 100 can provide improvements to existing methods typically employed to identify whether the tires of a vehicle are to be changed and to schedule a corresponding tire change service, by reducing or eliminating human effort involved in the process, reducing an inference time involved in the process, reducing delays and potential scenarios of non-compliance with regional regulations for tires and increasing vehicle safety by proactively identifying when a vehicle has unsuitable or worn out tires.

In various embodiments, non-limiting system 100 can be an early notification system comprising system 102. Discussion turns briefly to processor 104, memory 106 and bus 108 of system 102. For example, in one or more embodiments, system 102 can comprise processor 104 (e.g., computer processing unit, microprocessor, classical processor, and/or like processor). In one or more embodiments, a component associated with system 102, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, system 102 can comprise a computer-readable memory (e.g., memory 106) that can be operably connected to processor 104. Memory 106 can store computer-executable instructions that, upon execution by processor 104, can cause processor 104 and/or one or more other components of system 102 (e.g., early notification model 110, data collection component 202, data analysis component 204, alert component 206, scheduling component 208, training component 210, first AI model 212, second AI model 214 and third AI model 216) to perform one or more actions. In one or more embodiments, memory 106 can store computer-executable components (e.g., early notification model 110, data collection component 202, data analysis component 204, alert component 206, scheduling component 208, training component 210, first AI model 212, second AI model 214 and third AI model 216).

System 102 and/or a component thereof as described herein, can be communicatively, electrically, operatively, optically and/or otherwise coupled to one another via bus 108. Bus 108 can comprise one or more of a memory bus, memory controller, peripheral bus, external bus, local bus, and/or another type of bus that can employ one or more bus architectures. One or more of these examples of bus 108 can be employed. In one or more embodiments, system 102 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 102 can reside in the cloud, and/or can reside locally in a local computing environment (e.g., at a specified location(s)).

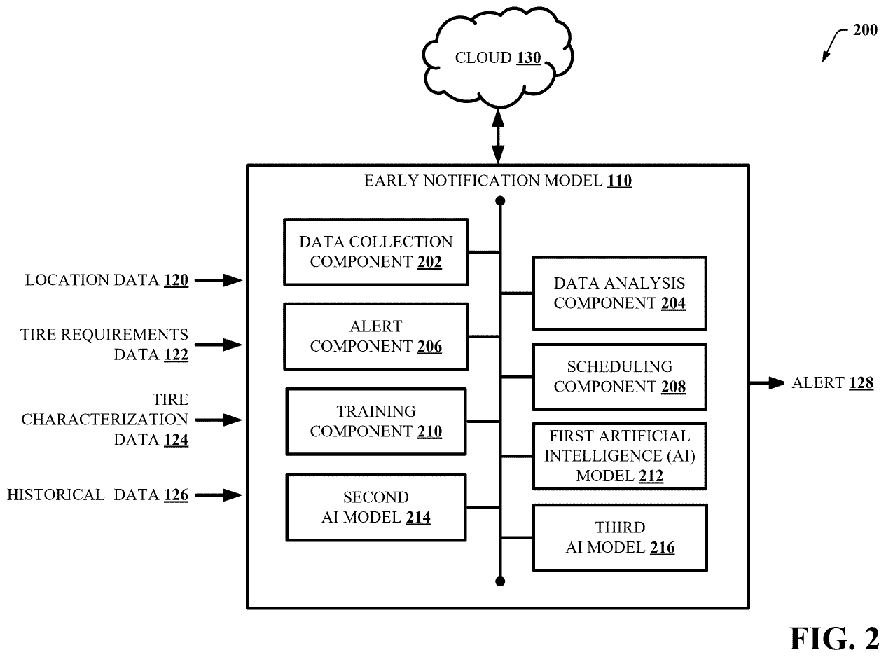

In various embodiments, system 102 can be an early notification system comprising early notification model 110. As illustrated in FIG. 2, early notification model 110 can further comprise data collection component 202, data analysis component 204, alert component 206, scheduling component 208, training component 210, first AI model 212, second AI model 214 and third AI model 216. In various embodiments, early notification model 110 can employ one or more of these components to analyze location data 120, tire requirements data 122, tire characterization data 124 and/or historical data 126 associated with a vehicle and determine, based on the analysis, whether the tires of the vehicle are safe for the vehicle and compliant with regional regulations of various locations to which the vehicle is expected to be driven. In various embodiments, early notification model 110 can make the determination without any intervention from an operator (e.g., hardware, software, machine, AI, neural network and/or user) and/or owner of the vehicle. Further, in various embodiments, upon a determination that the tires are unsafe or not compliant with the regional regulations, early notification model 110 can determine (i.e., infer/conclude/predict) that the tires are due for a change and automatically schedule a tire change service by analyzing various factors related to the vehicle and the operator of the vehicle.

### Data Collection

In various embodiments, data collection component 202 can collect location data 120, tire requirements data 122 and tire characterization data 124 for a vehicle. In various embodiments, data collection component 202 can be a machine learning algorithm or employ machine learning algorithms to collect and process the different types of data. In various embodiments, location data 120 can comprise information about a current geographic location of the vehicle, future geographic locations that the vehicle is expected to be driven to, a current date (e.g., October 11, current year), data from news channels and environmental information comprising weather conditions at the current geographic location of the vehicle and forecasted weather conditions at the future geographic locations that the vehicle is expected to be driven to. In various embodiments, tire requirements data 122 can comprise information about the regional regulations associated with the current geographic location of the vehicle and the future geographic locations that the vehicle is expected to be driven to. In various embodiments, tire characterization data 124 can comprise information about mechanical specifications of tires of the vehicle.

In various embodiments, data collection component 202 can collect location data 120, tire requirements data 122 and tire characterization data 124 for the vehicle via a set of sensors employed by the vehicle and databases accessible to data collection component 202.

For example, in an embodiment, data collection component 202 can employ internal sensors and/or external sensors (e.g., cameras, remote sensing systems, etc.) of the vehicle to collect tire characterization data 124 such as information about tire tread, tread depth, tire width, aspect ratio, speed rating, sidewall, rim diameter, overall diameter, tire pressure, tire type (e.g., winter tires, summer tires, all season tires), etc. for the one or more tires. In another embodiment, tire characterization data 124 can be periodically collected by the internal and/or external sensors of the vehicle and stored as sensor data in a memory accessible to data collection component 202, and data collection component 202 can collect the sensor data from the memory. In yet another embodiment, data collection component 202 can employ a machine learning model to collect tire characterization data 124, wherein the machine learning model can employ the internal and/or external sensors of the vehicle to detect tire characterization data 124.

In various embodiments, data collection component 202 can collect location data 120 via a global positioning system (GPS) sensor or device of the vehicle, location services, etc. For example, in an embodiment, data collection component 202 can access GPS data to determine the vehicle's geographic location. In another embodiment, an entity (e.g., hardware, software, machine, AI, neural network and/or user) operating the vehicle can manually or verbally enter a destination address into the location services (e.g., a routing service, maps, etc.) embedded in the vehicle, and data collection component 202 can access the location services to determine the geographic locations that the vehicle is expected to be driven to. In various embodiments, data collection component 202 can also collect weather data. For example, data collection component 202 can collect, based on current and/or future geographic locations associated with the vehicle, weather forecast data at that geographic location during the time period that the vehicle is expected to be at that geographic location. To collect the weather forecast data, data collection component 202 can access online sources such as weather channel websites, latest news, etc. For example, in an embodiment, data collection component 202 can act as a weather forecast integration component that can pull weather data from a reliable weather forecasting service. In another embodiment, data collection component 202 can pull weather data from news channels, social media, etc. that provide warning about upcoming weather such as severe winters, snow, winter storms, etc.

In various embodiments, data collection component 202 can collect tire requirements data 122 by accessing the relevant databases. For example, in an embodiment, data collection component 202 can access, based on a current geographic location and/or future geographic locations of the vehicle, a database of regional laws and regulations and road regulations pertaining to the current and/or the future geographic locations. Such a database can comprise information regarding the time to change the tires on a vehicle based on the region (e.g., city, state, country, etc.) that the vehicle is being operated in, roads with specific regulations for tires, etc. For example, the database can comprise data or maps highlighting roads that have specific tire requirements. Such a functionality of data collection component 202 can be deployed in situations where tire requirements depend on geographic locations.

### Data Analysis

In various embodiments, data analysis component 204 can determine, by analyzing location data 120 and tire requirements data 122 against tire characterization data 124, whether one or more tires of the vehicle are to be changed. For example, in various embodiments, data analysis component 204 can determine, based on the analyzing, whether the one or more tires are safe for regular operations of the vehicle and whether the one or more tires comply with regional regulations associated with a current geographic location of the vehicle and future geographic locations that the vehicle is expected to be driven to. For example, data analysis component 204 can perform a computational analysis to compare the existing tire tread on the one or more tires of the vehicle and determine whether the tread values are greater than an acceptable tread threshold for the specific type of tires according to certain weather conditions and regional regulations. Data analysis component 204 can perform such computational analyses for various parameters.

Upon a determination that the one or more tires are unsafe for regular operations of the vehicle and/or that the one or more tires do not comply with the regional regulations, data analysis component 204 can determine that the one or more tires are to be changed. In some embodiments, data analysis component 204 can be a traditional software or algorithm, such as a rule-based software, that can be programmed to analyze location data 120 and tire requirements data 122 against tire characterization data 124. In other embodiments, data analysis component 204 can employ first AI model 212 to analyze location data 120 and tire requirements data 122 against tire characterization data 124. For example, first AI model 212 can analyze an existing condition of the one or more tires of the vehicle and determine whether the tires are safe for upcoming weather, compliant with the regional and road regulations of a city that the vehicle is expected to be driven to, and so on.

As an example, the operator (e.g., hardware, software, machine, AI, neural network and/or user) of the vehicle can plan a trip to a mountainous region, and first AI model 212 can make a probabilistic determination that the tires are not suitable for the region due to the weather forecast and/or the mountainous terrain. As another example, if the vehicle is expected to be driven to the Swiss Alps or through multiple countries in Europe that have much colder climates and different respective tire-related regional rules and regulations than those at a current geographic location of the vehicle, first AI model 212 can factor such details into its analysis to determine whether the tires of the vehicle are due for a change. This can ensure that the vehicle is compliant with the regional rules and regulations of each geographic location that the vehicle can encounter in the near future. This functionality of data analysis component 204 can be very beneficial since some regions around the world have much stricter regulations related to the acceptable tread levels on vehicle tires, etc. than some others.

In this regard, first AI model 212 can be a multi-modal AI model built on a neural network, and first AI model 212 can employ techniques such as attention mechanisms to compare and learn from diverse data types (e.g., text, images, audio, video, structured data, etc.) to make complex determinations. For example, first AI model 212 can be a Bidirectional Encoder Representations from Transformers (BERT) model, a Contrastive Language Image Pre-training (CLIP) model, a Text-to-Text Transfer Transformer (T5) model, or another type of AI model. For example, first AI model 212 can be a BERT model that can be trained by training component 210 on historical weather reports, climate patterns and bulletins to extract relevant weather-relate outcomes such as temperature, snowfall, storm warnings, etc. from new weather data. Other models can be similarly trained to extract and compare data and make predictions. In some embodiments, first AI model 212 can be an ensemble comprising a CLIP model, a BERT model, a T5 model, etc. First AI model 212 can also comprise generative AI models that can interact with other AI models to perform one or more operations of first AI model 212.

In various embodiments, data analysis component 204 can further determine a risk associated with upcoming weather by analyzing, via second AI model 214, historical data 126 associated with the vehicle and location data 120. For example, second AI model 214 can analyze historical data 126 and location data 120 to predict when the temperature at a geographic location of the vehicle can be expected to drop to levels that necessitate winter tires. Based on such predictions, second AI model 214 can perform a risk analysis or risk assessment to calculate a risk, for example, of upcoming cold weather or another type of severe weather. Herein, historical data 126 can comprise information about past weather patterns, performance records of existing tires (e.g., summer tires) on the vehicle, and any other relevant historical data. In various embodiments, second AI model 214 can be or can employ one or more machine learning algorithms to make predictions and perform the risk analysis. For example, second AI model 214 can be a linear regression model, decision trees, Random Forest, Extreme Gradient Boosting (XGBoost) models, or another type of machine learning algorithm. For example, second AI model 214 can be a Random Forest model that can be trained by training component 210 to predict risky outcomes based on historical data 126 and location data 120 by learning patterns from past events. For example, the Random Forest model can aggregate outcomes from multiple decision trees to make accurate weather predictions, wherein each decision tree can evaluate the likelihood of risky outcomes based on different variables. In some embodiments, second AI model 214 can be an ensemble comprising a linear regression model, decision trees, Random Forest, Extreme Gradient Boosting (XGBoost) models, etc. Second AI model 214 can also comprise generative AI models that can interact with other AI models to perform one or more operations of second AI model 214.

In various embodiments, based on such analyses, data analysis component 204 can make additional determinations. For example, data analysis component 204 can identify the mechanical specifications of the tires to be installed in the vehicle. For example, data analysis component 204 can identify the most suitable tire brand and tire type that the vehicle should have according to the year, make and model of the vehicle. In one or more embodiments, data analysis component 204 can also evaluate a terrain at a geographic location that the vehicle is expected to travel to at a future time, and accordingly, recommend all-weather tires. In one or more embodiments, data analysis component 204 can recommend which vehicle from a fleet of vehicles (e.g., owned by an entity or company) can be the most suitable for geographic conditions and weather conditions at a future time. In one or more embodiments, data analysis component 204 can determine whether there are any open recalls from the vehicle manufacturer and factor such information into the analysis to determine whether the one or more tires are due for a change. For example, data analysis component 204 can employ first AI model 212 to look up the vehicle identification number (VIN) of the vehicle and check for open recalls. If an open recall includes a recall for tires, data analysis component 204 can determine that the vehicle is eligible for a free tire change service.

### Notification

In various embodiments, alert component 206 can generate, based on a determination by data analysis component 204 that the one or more tires of the vehicle are to be changed, alert 128 to the operator (e.g., hardware, software, machine, AI, neural network and/or user) of the vehicle. In various embodiments, in addition to alerting the operator (e.g., hardware, software, machine, AI, neural network and/or user) that the tires of the vehicle are due for a change, alert 128 can indicate a recommended date by which or a recommended time period within which the one or more tires are to be changed. For example, alert 128 can identify the latest date by which the tires should be changed. For example, based on the analysis performed by data analysis component 204, alert component 206 can identify the location-specific regulations for winter tires and accordingly determine that the vehicle is due for a tire change from summer tires to winter tires within two weeks and no later than three weeks from the date of the alert. In cases where winter tires are only required on specific roads, data analysis component 204 can employ a GPS device on-board the vehicle to check whether the vehicle is in the vicinity of such roads, and alert 128 can proactively warn the operator of the vehicle about the roads.

Alert 128 can generally comprise a variety of information that can be useful to the operator (e.g., hardware, software, machine, AI, neural network and/or user), such as information about upcoming weather, the climate at a future geographic location of the vehicle, tire-related laws based on weather and geographic locations, mechanical specifications of new tires, etc. Thus, alert component 206 can provide a warning/notification system that can inform the operator, in advance, that the vehicle is due for a tire change. In various embodiments, alert 128 can be provided to the operator via a driver information monitor (DIM) within the vehicle or via symbols (e.g., a warning light, text (e.g., a message), voice, etc.) displayed at a screen on the vehicle's dashboard. In one or more embodiments, alert component 206 can also enable a calendar and reminder system wherein alert component 206 can set reminders for the operator, based on the weather forecast data. For example, alert component 206 can alert the driver a few days in advance of a predicted drop in temperature at the geographic location of the vehicle and/or at future geographic locations of the vehicle.

### Scheduling

In various embodiments, scheduling component 208 can schedule, based on a determination that the one or more tires of the vehicle are to be changed, a tire change service at an auto shop, wherein scheduling the tire change service can comprise analyzing, by scheduling component 208, via third AI model 216, preferences of the operator (e.g., hardware, software, machine, AI, neural network and/or user) of the vehicle and a list of auto shops accessible by the vehicle. For example, based on the determination that the tires of the vehicle are to be changed, third AI model 216 can access a database of workshops (e.g., auto shops, garages, repair shops, service centers, auto repair facilities, auto dealership services etc.) that can be queried to determine time slots available at each workshop for changing the tires of the vehicles. Third AI model 216 can further access historical data 126 to identify workshop and time preferences of the operator. For example, third AI model 216 can determine that certain workshops have been the preferred choice of the operator for tire changes in the past because these workshops provide loyalty discounts on tires, offer hoteling attires such as facilities to store summer/winter tires at the workshops during the off seasons and so on.

Third AI model 216 can combine all the relevant data to identify suitable workshops for the tire change. In this regard, third AI model 216 can be an AI model directed to ranking and decision-making tasks. For example, third AI model 216 can be a collaborative filtering model, a content-based filtering model, a Learning to Rank (LTR) model, support vector machines (SVMs), a logistic regression model, decision trees, a Random Forest model, or another type of AI model. For example, third AI model 216 can be a decision tree that can be trained to rank different workshops based on a variety of criteria. Each node in the decision tree can represent a decision based on a criterion (e.g., tire change service cost, incentives, distance from the vehicle's geographic location, etc.), and the branches of the decision tree can represent the outcomes of the different decisions. In some embodiments, third AI model 216 can be an ensemble comprising a collaborative filtering model, a content-based filtering model, an LTR model, SVMs, a logistic regression model, decision trees, a Random Forest model, etc. Third AI model 216 can also comprise generative AI models that can interact with other AI models to perform one or more operations of third AI model 216.

Upon identifying a list of workshops that can provide the tire change service to the vehicle within the desired time period, scheduling component 208 can automatically contact a suitable workshop and schedule a tire change service at that workshop. In various embodiments, scheduling component 208 can also purchase tires in advance or pre-order tires on behalf of the operator (e.g., hardware, software, machine, AI, neural network and/or user) or owner of the vehicle. The functionalities of scheduling component 208 can reduce manual effort typically involved in scheduling tire change services, which can often take two or three days. In some cases, workshops do not have tires readily available for replacement, and the pre-ordering capabilities of scheduling component 208 can simplify the coordination involved in ensuring that a tire change service is scheduled at the appropriate time and that the suitable tires are available for replacement. In an embodiment, scheduling component 208 can generate a list of suitable workshops based on the geographic location of the vehicle, servicing availability, pricing, preset personal preferences of the operator, etc., and scheduling component 208 can present the list to the operator or owner with the option to select the desired workshop and book an appointment. The list can be presented to the operator at a screen or display on the vehicle's dashboard and/or on a device (e.g., a smartphone, a tablet, a laptop, a desktop computer, etc.) accessible to the operator, and the operator can have the option to reorganize the list according to various filters. For example, the operator can have the option to organize the list in ascending order of the servicing availability, in descending order of the number of discounts on tire changes, and so on.

### Training

In various embodiments, training component 210 can periodically train first AI model 212 employed by data analysis component 204 to analyze location data 120 and tire requirements data 122 against tire characterization data 124. To training first AI model 212, training component 210 can aggregate performance data and feedback data associated with performance of data analysis component 204, over a defined duration of time. For example, in one or more embodiments, the operator (e.g., hardware, software, machine, AI, neural network and/or user) of the vehicle can have the option to provide feedback on alert 128, wherein the operator can evaluate the information comprised in alert 128 and provide feedback indicating whether alert 128 was generated at the right time, whether the dates for scheduling the tire change have been correctly predicted by data analysis component 204, and so on. Such feedback can be aggregated by training component 210 over a defined duration of time (e.g., 15 days, a month, etc.) and stored in the vehicle's memory (e.g., memory 106) or on the cloud (e.g., cloud 130) along with the corresponding performance data (e.g., temperature data, dates predicted for the tire change, secondary evaluation values, etc.) of data analysis component 204.

In various embodiments, training component 210 can access the aggregated feedback and performance data to generate a training dataset. In various embodiments, the training dataset can be periodically updated by training component 210 as new feedback and performance data becomes available. In one or more embodiments, training component 210 can crowdsource data (e.g., weather forecast data, operator preferences, context, availability of tires with certain mechanical specifications, performance and feedback data, etc.) collected from multiple vehicles. The crowdsourced data can be collected from multiple vehicles that can be connected to cloud 130. Such crowdsourced data can be combined with the performance data and the feedback data associated with performance of data analysis component 204 to generate the training dataset. In various embodiments, training component 210 can employ the training dataset to update parameters of first AI model 212. For example, training component 210 can periodically train first AI model 212. During the training, first AI model 212 can minimize its loss function, as a result of which the parameters of first AI model 212 can be iteratively updated. The specifics of how the loss function of first AI model 212 can be minimized and parameters updated can depend on the specific AI model.

In some embodiments, training component 210 can train first AI model 212, locally (e.g., within system 102). In other embodiments, training component 210 can train first AI model 212 within cloud 130. Cloud 130 can be a cloud-based environment that system 102 can be connected to (e.g., communicatively, operatively, etc.) to store data, access information, etc. Since the training dataset employed to train first AI model 212 can comprise sensitive data such as personal preferences and information about the vehicle, the operator of the vehicle, etc., the cloud-based training can be performed discretely and in a decentralized manner such as, for example, via federated learning, to address privacy concerns and keep sensitive data local to a vehicle. In federated learning, first AI model 212 can be trained without sharing local data with a cloud-based central server provided by cloud 130.

More specifically, training component 210 can train first AI model 212 as a local model within system 102, for example, based on local data associated with a vehicle. Thereafter, training component 210 can deploy updated parameters (e.g., weights and gradients) of first AI model 212 to the cloud-based central server. The cloud-based central server can also access updated parameters of locally trained models identical to first AI model 212, from other vehicles equipped with early notification model 110 (e.g., from a fleet of vehicles manufactured by an Original Equipment Manufacturer (OEM)). The updated parameters from the various vehicles can be aggregated within cloud 130, and the aggregated parameters can be employed to train a global AI model that can be re-deployed as first AI model 212 within the early notification model 110 of each vehicle. On the contrary, in some embodiments, first AI model 212 can only be trained locally or via any combination of local and cloud-based training. In general, first AI model 212 can be trained to be robust and generate very customized and optimized recommendations based on operator preferences (e.g., on criteria such as budget, proactiveness of the operator, etc.), wear and tear on the tires and so on.

In one or more embodiments, training component 210 can train a more customized version of first AI model 212 locally, based on the driving patterns, use patterns, etc. of the operator (e.g., hardware, software, machine, AI, neural network and/or user). For example, if the driver of the vehicle is known to prefer hiking in the mountains where the weather is icier than that at sea level, first AI model 212 can be trained to employ such information to determine when the tires of the vehicle are due for a change.

In embodiments wherein first AI model 212 can comprise multiple other models, training component 210 can individually and periodically train each model comprised in first AI model 212. In various embodiments, training component 210 can similarly train second AI model 214 and third AI model 216 and/or individual models comprised in second AI model 214 and third AI model 216. For example, training component 210 can build respective training datasets to train respective models, and during training, each model can minimize its loss function and update its parameters. In various embodiments, second AI model 214 and third AI model 216 can be trained locally and/or on cloud 130.

The following describes exemplary practical applications of the embodiments of the present disclosure.

In an exemplary scenario, system 102 can be deployed in a car that primarily operates in Sweden. Based on GPS data (e.g., location data 120), data collection component 202 can determine the geographic location of the car and access databases comprising the regional regulations of Sweden. Further, data collection component 202 can identify the dates when cars are legally required to have winter tires in Sweden. Data collection component 202 can also collect tire requirements data 122 and tire characterization data 124 for the car. Based on the collected data, data analysis component 204 can determine that the tires of the car are due for a change. Accordingly, alert component 206 can generate alert 128 informing the operator/driver of the car via a built-in system in the car to change the winter tires. If the tire change is not due immediately, alert component 206 can provide the driver with the option to receive a tire change reminder at a future date. In one or more embodiments, the reminder can be provided to the driver as a warning light on the car's dashboard, a message on a monitor or screen inside the car, a voice alert, and so on. Simultaneously, scheduling component 208 can identify and present a list of workshops within a defined geographical radius of the car, and the driver can reserve a time for a tire change service. Alternatively, scheduling component 208 can automatically identify the most suitable workshop and schedule the tire change service by analyzing the driver's preferences and schedule.

In another exemplary scenario, data analysis component 204 can employ weather forecast data and data from news channels to anticipate the onset of cold weather that can involve the use of winter tires. In this context, alert component 206 can proactively inform the driver about impending weather conditions, such as snowfall. Furthermore, scheduling component 208 can provide the driver with the convenience of booking a workshop visit in advance, thereby avoiding a last-minute servicing rush and potential queues at the workshop. This exemplary scenario can be applicable to regions where the use of winter tires is based on weather conditions.

In another exemplary scenario, the car can primarily be operated in an area where tire restrictions apply only to specific regions/roads. In this scenario, data collection component 202 can access a database or map of such regions/roads, and data collection component 202 can further collect GPS data for the car. The collected data can be analyzed by data analysis component 204 to determine that the car's tires are due for a change, and alert component 206 can alert the driver about the potential for winter tires. Additionally, alert component 206 can provide a map of the regions/roads with specific tire restrictions so that the driver can determine whether they can expect to encounter one or more of the regions/roads, for example, on their route to work, home, school, etc. Such a proactive approach of early notification model 110 can ensure that the driver is always prepared and compliant with regional tire regulations.

In each exemplary scenario, early notification model 110 can automatically schedule a workshop visit for a tire change and reserve a time for the tire change service based on location, price, servicing availability of workshops, time availability, etc. For example, scheduling component 208 can provide the driver with the option to manually schedule a workshop visit or to allow the scheduling component 208 to automatically schedule the workshop visit. In one or more embodiments, the driver can also have the option to indefinitely allow scheduling component 208 to automatically schedule workshop visits when they are due. Alternatively, in one or more embodiments, the driver can choose to manually schedule each workshop visit based on workshops identified by scheduling component 208. In general, scheduling component 208 can provide a wide range of flexibility with varying degrees of autonomy in scheduling workshop visits (e.g., fully automatic scheduling, fully manual scheduling, or any combination of autonomous and manual scheduling).

FIG. 2 illustrates another block diagram of an example, non-limiting system 200 that can detect, based on weather conditions, regional regulations and a current state of tires of a vehicle, whether the tires of the vehicle are due for a change, in accordance with one or more embodiments described herein. Repetitive description of like elements and/or processes employed in respective embodiments is omitted for sake of brevity.

Non-limiting system 200 illustrates the system of early notification model 110. As described with reference to FIG. 1, early notification model 110 can further comprise data collection component 202, data analysis component 204, alert component 206, scheduling component 208, training component 210, first AI model 212, second AI model 214 and third AI model 216.

It should be appreciated that non-limiting system 200 can be deployed within a variety of vehicles such as gasoline powered vehicles, hybrid vehicles, fully electric vehicles, etc. Non-limiting system 200 can also be deployed within partially or fully autonomous vehicles. Accordingly, in some embodiments, the operator of a vehicle can be a human driver, whereas in other embodiments, the operator of the vehicle can be a hardware, software, machine, AI and/or neural network. In various embodiments, early notification model 110 can interact with the Autonomous Driving System (ADS) or Autonomous Vehicle Operating System (AVOS) of an autonomous vehicle to perform the various operations described in one or more embodiments. For example, upon a determination by data analysis component 204 that the tires of an autonomous vehicle are due for a change, alert component 206 can signal the ADS that a tire change is due, and scheduling component 208 can simultaneously interact with the ADS to automatically identify and schedule a workshop visit for a tire change service. When the workshop visit is due, the ADS can drive the autonomous vehicle to the workshop where the tire change service has been scheduled by scheduling component 208. Such embodiments can be especially advantageous to older people, people with health issues or generally people that cannot afford to spend time scheduling visits.

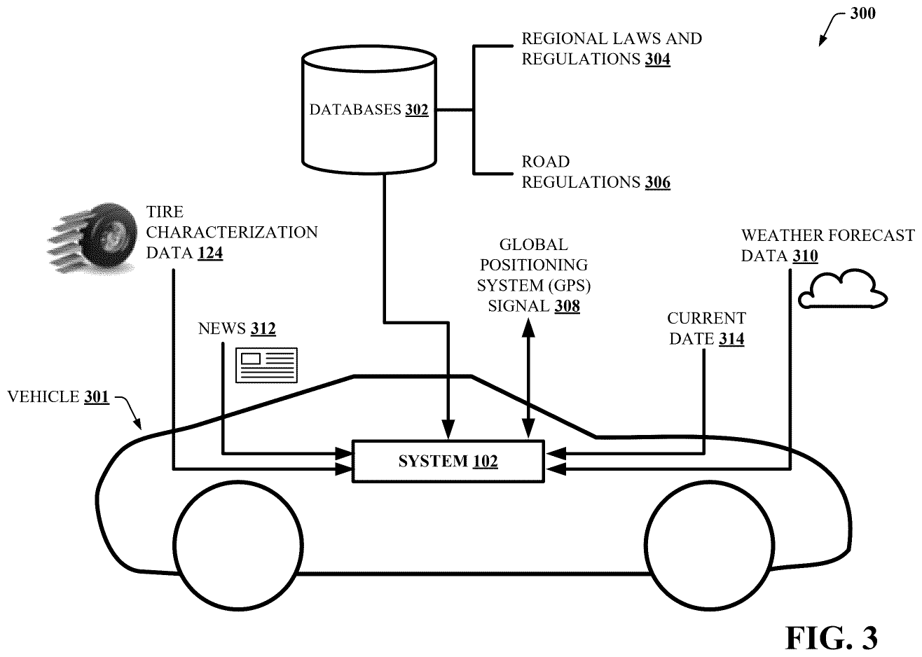

FIG. 3 illustrates a diagram of an example, non-limiting system 300 that can detect, based on weather conditions, regional regulations and a current state of tires of a vehicle, whether the tires of the vehicle are due for a change, in accordance with one or more embodiments described herein. Repetitive description of like elements and/or processes employed in respective embodiments is omitted for sake of brevity.

Non-limiting system 300 illustrates vehicle 301 that can be equipped with system 102 described with reference to FIGS. 1 and 2. In various embodiments, early notification model 110 can act as a system that can enable planned trips. For example, data collection component 202 can collect location data 120, tire requirements data 122 and tire characterization data 124, via a set of sensors employed by vehicle 301 and from databases 302, for relevant regions and roads along a planned or predetermined route that vehicle 301 is expected to travel upon. For example, an operator (e.g., hardware, software, machine, AI, neural network and/or user) of vehicle 301 can plan a trip to a holiday destination. Data collection component 202 can proactively check or determine a geographic location of vehicle 301 via GPS signal 308, collect weather forecast data 310 such as future weather conditions at geographic locations that vehicle 301 is expected to be driven to, identify current date 314 from news 312 or other online sources, collect tire characterization data 124 such as tire type, tire tread, tread depth, etc. via internal and/or external sensors of vehicle 301, identify regional laws and regulations 304 and road regulations 306 from databases 302 describing tire-related regulations of specific roads, collect historical data and so on. Databases 302 can be accessible via cloud 130 (FIGS. 1 and 2) or a memory device within the vehicle. In one or more embodiments, data collection component 202 can aggregate new information about tire-related regional laws and regulations and road regulations, and data collection component 202 can add the new information to databases 302 and/or update the information comprised in databases 302, thereby ensuring that databases 302 comprise the most up-to-date data.

In various embodiments, data analysis component 204 can analyze location data 120 and tire requirements data 122 against tire characterization data 124 to determine whether vehicle 301 is fitted with the most appropriate tires. Accordingly, if the planned trip involves the use of different tires than those that vehicle 301 is equipped with, data analysis component 204 can decide that vehicle 301 is due for a tire change service. In some cases, the different data collected by data collection component 202 can lead to conflicting recommendations. For example, weather forecast data 310 can indicate that the tires of vehicle 301 do not need to be changed from summer tires to winter tires or all-weather tires for the planned trip, whereas regional laws and regulations 304 can indicate that tires of vehicle 301 should be changed from summer tires to winter tires for the planned trip. In such cases, data analysis component 204 can recommend the safest legal option (e.g., winter tires) as the appropriate solution. Accordingly, alert 128 can be presented to the operator (e.g., hardware, software, machine, AI, neural network and/or user), and scheduling component 208 can automatically schedule a tire change service at a workshop or present a list of workshops to the operator with the option to select a suitable workshop and manually schedule the tire change service.

In one or more embodiments, the various functionalities and embodiments discussed with reference to early notification model 110 can be built-in functionalities in vehicle 301 that the operator (e.g., hardware, software, machine, AI, neural network and/or user) or owner of vehicle 301 can subscribe to, or that can be implemented within a software application provided by the OEM of vehicle 301 and made accessible either at no cost or as a subscription. In an embodiment, early notification model 110 can also be provided as a software module in the vehicle, for example, via cloud 130. In one or more embodiments, early notification model 110 can be provided by the OEM as part of an on-board computer than can be retrofitted into a vehicle. It should be appreciated that although vehicle 301 is illustrated as a car in FIG. 3, vehicle 301 can be any suitable vehicle such as a truck, a minivan, and so on.

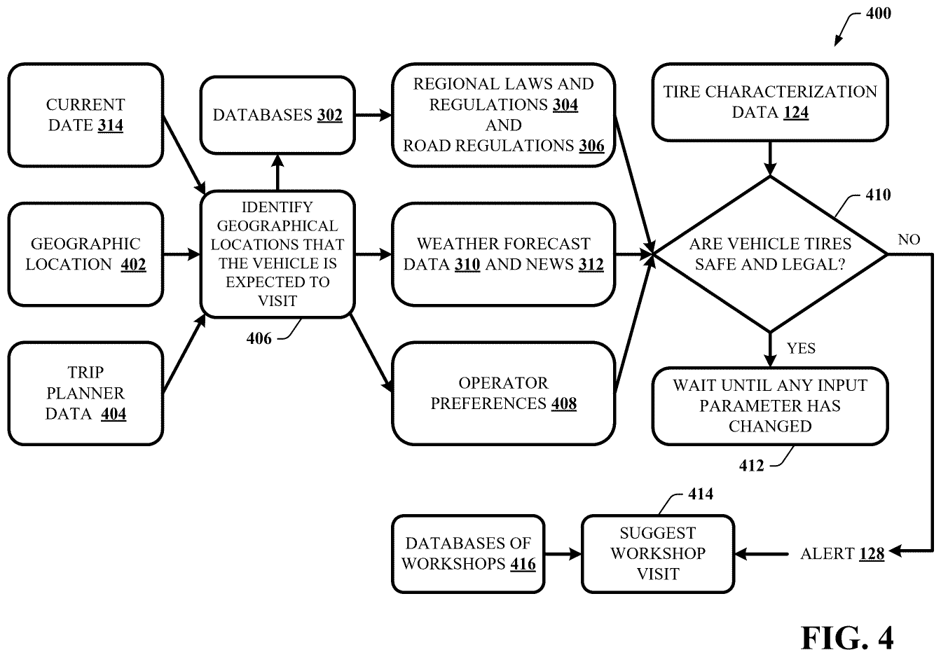

FIG. 4 illustrates a flow diagram of an example, non-limiting method 400 that can detect, based on weather conditions, regional regulations and a current state of tires of a vehicle, whether the tires of the vehicle are due for a change, in accordance with one or more embodiments described herein. Repetitive description of like elements and/or processes employed in respective embodiments is omitted for sake of brevity.

Non-limiting method 400 illustrates an exemplary scenario wherein early notification model 110 illustrated in FIGS. 1 and 2 can evaluate various types of data related to a vehicle, determine whether the tires of the vehicle are to be changed, and schedule a tire change service at a workshop.

At 406, data collection component 202 can identify, based on current date 314, geographic location 402, and trip planner data 404, geographic locations that the vehicle is expected to be driven to. For example, current date 314 can indicate the day and month of the year, geographic location 402 can indicate the geographic location of the vehicle based on GPS data and trip planner data 404 can comprise data from trips planned by one or more operators (e.g., hardware, software, machine, AI, neural network and/or user) of the vehicle. Trip planner data 404 can be entered into the vehicle's on-board system via a trip planner or trip planning system within the vehicle or within a device (e.g., smartphone, tablet, etc.) accessible to the operator. In various embodiments, based on current date 314, geographic location 402 and trip planner data 404 collected by data collection component 202, data collection component 202 can identify relevant regions and/or roads that the vehicle is expected to be driven to at a future time (e.g., within 10 days, within a month, etc.).

In various embodiments, data collection component 202 can also access databases 302 comprising information about regional laws and regulations 304 by date, regional tire requirements and road regulations 306 comprising information about roads with specific tire requirements. Based on the geographic locations that the vehicle is expected to be driven to in the near future, data collection component 202 can collect from databases 302, information about regional laws and regulations and road regulations relevant to the specific regions and/or roads. Additionally, data collection component 202 can access weather forecast data 310 and news 312 to identify the weather forecast and latest news relevant to the specific regions and/or roads that the vehicle is expected to be driven to. Data collection component 202 can also collect from historical data 126, operator preferences 408, wherein operator preferences 408 can indicate preferences of the operator (e.g., hardware, software, machine, AI, neural network and/or user) of the vehicle, and wherein operator preferences 408 can be preset and optionally region-dependent or road-dependent. Finally, data collection component 202 can collect tire characterization data 124 such as tire type (e.g., summer, winter, all season), tire tread, tread depth, etc. related to existing tires on the vehicle.

At 410, the data collected by data collection component 202 can be accessed by data analysis component 204 that can evaluate the data (e.g., by employing first AI model 212 or a traditional software) and determine, based on the evaluation, whether the tires of the vehicle are safe and legal, considering all factors. If yes, then at 412, data analysis component 204 can wait to perform another analysis until any input parameter to data analysis component 204 has changed. For example, data analysis component 204 can periodically or continuously access the data collected by data collection component 202 as input data, and if there is no change in the input data, data analysis component 204 can remain in a standby mode. In not, then alert component 206 can generate alert 128, as described with reference to FIG. 1, to inform the operator (e.g., hardware, software, machine, AI, neural network and/or user) via a notification or warning that the tires of the vehicle are due for a change.

At 414, scheduling component 208 can suggest a workshop visit to the operator (e.g., hardware, software, machine, AI, neural network and/or user) based on factors such as location, price, servicing availability, personal preferences of the operator, etc. For example, scheduling component 208 can access databases of workshops 416 comprising a list of workshops with pricing for tire change services, timing availability and other details for tire changes services offered by each workshop. Based on the databases of workshops, scheduling component 208 can generate a list of workshops within a defined or preferred geographic distance from the operator. Scheduling component 208 can present the list of workshops to the operator, or scheduling component 208 can automatically identify the most appropriate workshop and schedule a tire change service on behalf of the operator.

In various embodiments, scheduling component 208 can evaluate factors such as the potential availability of tires with suitable mechanical specifications at different workshops, the availability of mechanics, sale price points and discounts on tires, early bird incentives offered by workshops, family incentives such as candies for children of the vehicle owner, etc. to generate the list of workshops. For example, a workshop can offer a 20% discount to vehicles that schedule a tire change service well in advance of the first snow to avoid overwhelming their mechanics. The workshop can also offer to store summer tires throughout the duration of the winter for a monthly fee and vice versa. Scheduling component 208 can evaluate, via third AI model 216, preferences of the owner of the vehicle and identify that the workshop is the most suitable for the tire changes service recommended by data analysis component 204 according to the budget preferences of the owner, given the incentives. Subsequently, scheduling component 208 can act on behalf of the owner and automatically schedule the tire change service at the workshop.

Thus, in various embodiments, early notification model 110 can reduce or entirely eliminate the manual effort from workshops or vehicle users that is typically involved in determining when the tires of a vehicle are due for a change. Early notification model 110 can do this by automating, via various models (e.g., first AI model 212, second AI model 214, third AI model 216, machine learning algorithms, etc.) and/or traditional software (e.g., rule-based software), the efforts otherwise involved in data collection and analysis.

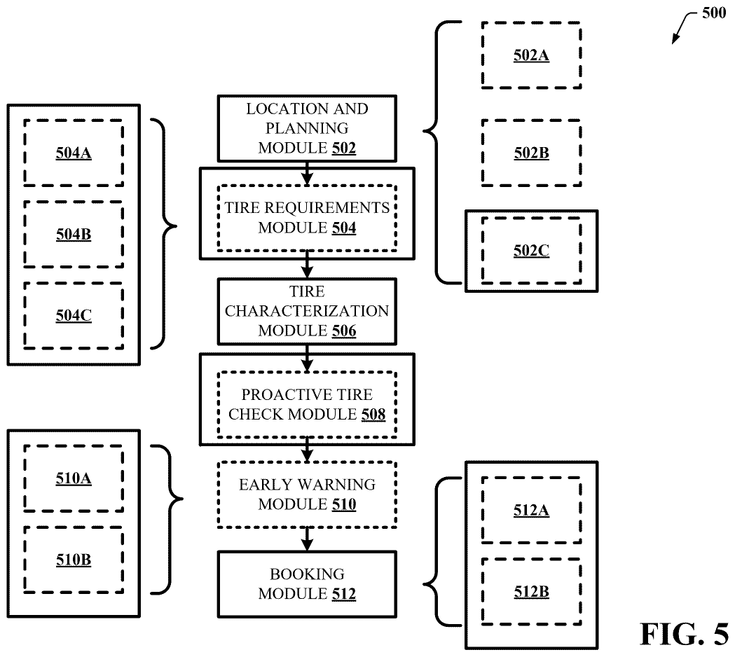

FIG. 5 illustrates an example, non-limiting flow diagram 500 of modules that can detect, based on weather conditions, regional regulations and a current state of tires of a vehicle, whether the tires of the vehicle are due for a change, in accordance with one or more embodiments described herein. Repetitive description of like elements and/or processes employed in respective embodiments is omitted for sake of brevity.

With continued reference to at least FIGS. 1 and 2, non-limiting flow diagram 500 presents a list of modules. In one or more embodiments, the modules illustrated in FIG. 5 can be employed by one or more components of early notification model 110 to perform their respective sets of operations, or the modules can be analogous to components of early notification model 110. For example, data collection component 202 can employ location and planning module 502, tire requirements module 504 and tire characterization module 506, data analysis component 204 can employ proactive tire check module 508, alert component 206 can employ early warning module 510, and scheduling component 208 can employ workshop time booking module 512. In one or more embodiments, each of these modules can be comprised by early notification model 110 and are described in greater detail, as follows:

Location and planning module 502 can identify, based on multiple sources (e.g., 502A-C), where a vehicle is located and where it is expected to be at a future time period. Data 502A can comprise the current date that can be collected, for example, from the infotainment system within the vehicle, a smart device connected to the vehicle, etc., data 502B can indicate the geographical location of the vehicle based on GPS data, and data 502C can comprise trip planner data comprising information about trips planned by an owner or operator of the vehicle and registered and stored to vehicle memory via a trip planner. If the vehicle does not comprise a trip planner or no planned trips are registered, data collection component 202 can make an assumption or prediction that the vehicle is expected to remain in its regular area of operation or around an existing location of the vehicle.

Tire requirements module 504 can retrieve tire requirements based on a current geographic location and a planned future geographic location of the vehicle, based on local news by date and forecasted weather. Data 504A can comprise a database with regional regulations by date (laws/requirements), data 504B can comprise a database of roads with specific tire requirement, and data 504C can comprise weather forecasts for regions that the vehicle is expected to be driven to at a future period.

Tire characterization module 506 can identify relevant tire characteristics such as tire type, tire tread, tread depth, etc. of existing tires of the vehicle based on signal data in the vehicle.

Proactive tire check module 508 can analyze whether the existing tires of the vehicle are safe and legal for geographic locations, planned trips, times and weather conditions that the vehicle is expected to experience. In this regard, proactive tire check module 508 can be analogous to first AI model 212.

Based on the output from proactive tire check module 508, early warning module 510 can generate, at 510A, an advanced warning to an operator (e.g., hardware, software, machine, AI, neural network and/or user) of the vehicle informing the operator that the tires of the vehicle are to be changed by displaying symbols and/or messages on the dashboard of the vehicle, on a device (e.g., smartphone, tablet, etc.) accessible to the operator, or by any other suitable means. Additionally, early warning module 510 can indicate, at 510B, to the operator, a recommended time as well as the latest time when a tire change service can be performed.

Workshop time booking module 512 can automatically reserve a slot for a tire change service for the vehicle based on parameters comprised in data 512A and data 512B, if the output from proactive tire check module 508 indicates that the tires of the vehicle are due for a change. Data 512A can comprise a list of workshops in the vicinity of the vehicle and/or along a planned route that the vehicle is expected to travel along, including workshop-specific information about vacant service slots, servicing availabilities, availabilities of tires and other parts, pricing, ratings/reviews, etc. Data 512B can comprise workshop selection preferences of the operator or owner of the vehicle such as preferences for specific workshops, limits on distance, price or other parameters that the owner or operator is willing to expend, availability of the owner or operator based on their calendar, etc.

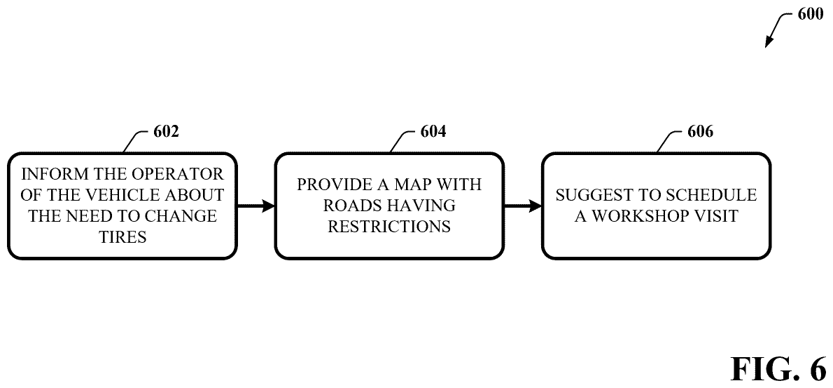

FIG. 6 illustrates a flow diagram of an example, non-limiting method 600 that can be employed to schedule a tire change service, in accordance with one or more embodiments described herein. Repetitive description of like elements and/or processes employed in respective embodiments is omitted for sake of brevity.

Non-limiting method 600 illustrates embodiments of alert component 206 and scheduling component 208 illustrated in FIGS. 1 and 2.

At 602, alert component 206 can inform an operator (e.g., hardware, software, machine, AI, neural network and/or user) of a vehicle that the tires of the vehicle are due to be changed. Such information can be presented to the operator via one or more symbols, a voice notification, a text message notification, etc. at a DIM, screen or application connected to the vehicle or embedded within the vehicle.

At 604, alert component 206 can additionally provide the operator with a map showing roads with specific tire restrictions. The map can also indicate whether the tire restrictions apply only to specific regions within the country, state, city, etc. of the vehicle and include all regions along a planned trip.

At 606, scheduling component 208 can suggest the operator to schedule a tire change service at a workshop based on the location of the workshop, the price of the tire change service, servicing vacancies at the workshop and a number of other relevant factors.

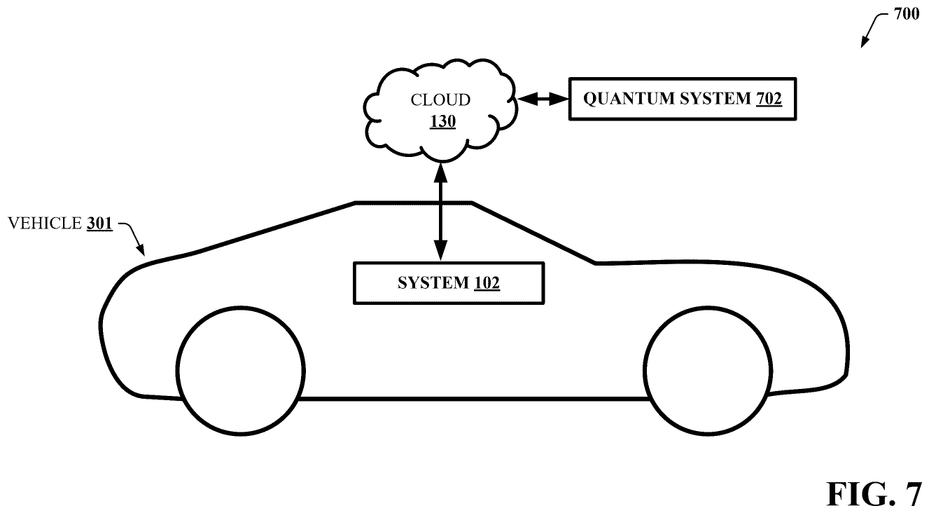

FIG. 7 illustrates a diagram of an example, non-limiting system 700 that can employ cloud-based quantum computing to determine whether the tires of a vehicle are due for a change, in accordance with one or more embodiments described herein. Repetitive description of like elements and/or processes employed in respective embodiments is omitted for sake of brevity.

As discussed with reference to at least FIGS. 1-6 , early notification model 110 can perform various operations by employing AI models (e.g., first AI model 212, second AI model 214 and third AI model 216), machine learning algorithms and/or rule-based software. In one or more embodiments, one or more components of early notification model 110 (e.g., data collection component 202, data analysis component 204, alert component 206, scheduling component 208, training component 210, first AI model 212, second AI model 214 and third AI model 216) can also employ cloud-based quantum computing to perform one or more operations to evaluate various types of data related to the tires of a vehicle, determine whether the tires of the vehicle are to be changed, and schedule a tire change service at a workshop. For example, system 102 can be deployed in a vehicle. Additionally, system 102 can be connected (e.g., communicatively, operatively, etc.) to cloud 130, and cloud 130 can be connected (e.g., communicatively, operatively, etc.) to quantum system 702. Quantum system 702 can comprise at least one quantum processor comprising a quantum logic circuit. The quantum logic circuit can further comprise one or more qubits. The quantum processor can be any suitable processor, and the quantum processor can generate one or more instructions for controlling the quantum logic circuit. Cloud 130 can act as an interface between quantum system 702 and system 102 such that one or more operations of early notification model 110 can be performed by cloud-based quantum computing.

For example, quantum system 702 can be a quantum computer. Quantum computers can handle vast amounts of data such as information about routes, regional laws and regulations for different regions, road regulations for different streets, weather conditions, etc. Training component 210 can employ the functionality of quantum system 702 to handle large amounts of data to generate and periodically update training datasets to train one or more components of early notification model 110. Quantum system 702 can efficiently handle and aggregate large amounts of data from multiple vehicles, wherein such data can be employed by training component 210 to generate the training datasets. Additionally, data analysis component 204 can employ quantum system 702 to process data from multiple sources such as GPS modules of a vehicle, datasets comprising extensive information related to tire-related laws and regulations by region, etc., for example, via quantum machine learning (QML) algorithms that can be executed on quantum system 702, to make accurate determinations regarding whether the tires on a vehicle are due for a change. Recall that in some embodiments, early notification model 110 can act as a system that can enable planned trips. In such embodiments, quantum system 702 can execute QML algorithms to dynamically determine the most suitable routes by evaluating large amounts of GPS data collected by data collection component 202. The corresponding results can be presented to an operator (e.g., hardware, software, machine, AI, neural network and/or user) of the vehicle via cloud 130.

In general, early notification model 110 can employ cloud-based quantum computing to optimize decision-making processes of one or more components comprised in early notification model 110. In some embodiments, system 102 can also be accessed by the vehicle via cloud 130. For example, system 102 can perform cloud-based interactions with on-board systems of the vehicle and with quantum system 702 to provide the one or more functionalities of early notification model 110 described in this specification. As quantum computing becomes ubiquitous, in the distant future, a scaled down version of quantum system 702 can also be directly embedded inside a vehicle to make determinations regarding tire changes, etc. in conjunction with early notification model 110.

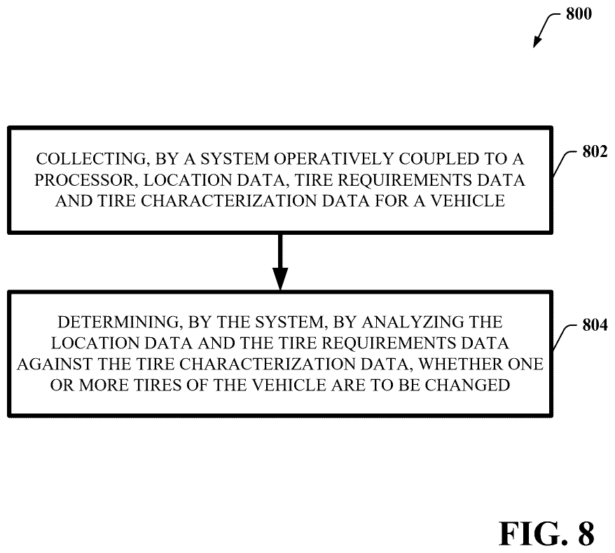

FIG. 8 illustrates a flow diagram of an example, non-limiting method 800 that can detect, based on weather conditions, regional regulations and a current state of tires of a vehicle, whether the tires of the vehicle are due for a change, in accordance with one or more embodiments described herein. Repetitive description of like elements and/or processes employed in respective embodiments is omitted for sake of brevity.

At 802, non-limiting method 800 can comprise collecting (e.g., by data collection component 202), by a system operatively coupled to a processor, location data, tire requirements data and tire characterization data for a vehicle.

At 804, non-limiting method 800 can comprise determining (e.g., by data analysis component 204), by the system, by analyzing the location data and the tire requirements data against the tire characterization data, whether one or more tires of the vehicle are to be changed.

In various instances, machine learning algorithms or models can be implemented in any suitable way to facilitate any suitable aspects described herein. To facilitate some of the above-described machine learning aspects of various embodiments, consider the following discussion of artificial intelligence (AI). Various embodiments described herein can employ AI to facilitate automating one or more features or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system or environment from a set of observations as captured via events or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events or data.

Such determinations can result in the construction of new events or actions from a set of observed events or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes or systems (e.g., support vector machines, neural networks, expert systems, Bayesian belief networks, fuzzy logic, data fusion engines, and so on) in connection with performing automatic or determined action in connection with the claimed subject matter. Thus, classification schemes or systems can be used to automatically learn and perform a number of functions, actions, or determinations.

A classifier can map an input attribute vector, z=(z₁, z₂, z₃, z₄, . . . , zₙ), to a confidence that the input belongs to a class, as by f(z)=confidence(class). Such classification can employ a probabilistic or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, or probabilistic classification models providing different patterns of independence, any of which can be employed. Classification as used herein also is inclusive of statistical regression that is utilized to develop models of priority.

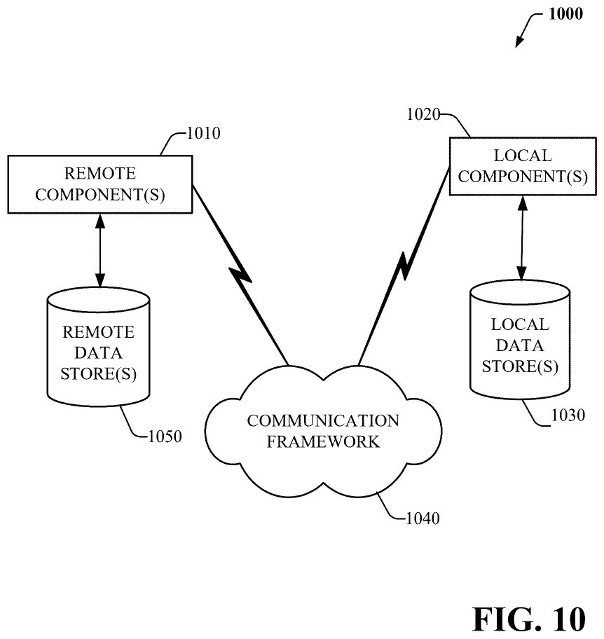

Turning next to FIGS. 9 and 10, a detailed description is provided of additional context for the one or more embodiments described herein with reference to FIG. 1-9.

In order to provide a context for the various aspects of the disclosed subject matter, FIG. 9 as well as the following discussion are intended to provide a general description of a suitable environment in which the various aspects of the disclosed subject matter can be implemented. FIG. 9 illustrates a block diagram of an example, non-limiting operating environment in which one or more embodiments described herein can be facilitated. Repetitive description of like elements employed in other embodiments described herein is omitted for sake of brevity. With reference to FIG. 9, a suitable operating environment 900 for implementing various aspects of this disclosure can also include a computer 912. The computer 912 can also include a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914. The system bus 918 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), Small Computer Systems Interface (SCSI), a controller area network (CAN) bus, and a local interconnect network (LIN) bus. The system memory 916 can also include volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM)). Volatile memory 920 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 912 can also include removable/non-removable, volatile/non-volatile computer storage media. FIG. 9 illustrates, for example, a disk storage 924. Disk storage 924 can also include, but is not limited to, devices like a magnetic disk drive, floppy disk drive, tape drive, Jaz drive, Zip drive, LS-100 drive, flash memory card, or memory stick. The disk storage 924 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 924 to the system bus 918, a removable or non-removable interface is typically used, such as interface 926. FIG. 9 also depicts software that acts as an intermediary between users and the basic computer resources described in the suitable operating environment 900. Such software can also include, for example, an operating system 928. Operating system 928, which can be stored on disk storage 924, acts to control and allocate resources of the computer 912. System applications 930 take advantage of the management of resources by operating system 928 through program modules 932 and program data 934, e.g., stored either in system memory 916 or on disk storage 924. It is to be appreciated that this disclosure can be implemented with various operating systems or combinations of operating systems. A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port can be used to provide input to computer 912, and to output information from computer 912 to an output device 940. Output adapter 942 is provided to illustrate that there are some output devices 940 like monitors, speakers, and printers, among other output devices 940, which require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a computer, a server, a router, a network PC, a workstation, a microprocessor-based appliance, a peer device or other common network node and the like, and typically can also include many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 950 refers to the hardware/software employed to connect the network interface 948 to the system bus 918. While communication connection 950 is shown for illustrative clarity inside computer 912, it can also be external to computer 912. The hardware/software for connection to the network interface 948 can also include, for example purposes only, internal and external technologies such as, modems including regular telephone grade modems, cable modems and DSL modems, ISDN adapters, and Ethernet cards.

The illustrated embodiments described herein can be employed relative to distributed computing environments (e.g., cloud computing environments), such as described below with respect to FIG. 10, where certain tasks are performed by remote processing devices that are linked through a communications network. In a distributed computing environment, program modules can be located both in local and/or remote memory storage devices.

For example, one or more embodiments described herein and/or one or more components thereof can employ one or more computing resources of the cloud computing environment described below with reference to illustration 1000 of FIG. 10. For instance, one or more embodiments described herein and/or components thereof can employ such one or more resources to execute one or more: mathematical function, calculation and/or equation; computing and/or processing script; algorithm; model (e.g., artificial intelligence (AI) model, machine learning (ML) model, deep learning (DL) model, and/or like model); and/or other operation in accordance with one or more embodiments described herein.

It is to be understood that although one or more embodiments described herein include a detailed description on cloud computing, implementation of the teachings recited herein are not limited to a cloud computing environment. Rather, one or more embodiments described herein are capable of being implemented in conjunction with any other type of computing environment now known or later developed. That is, the one or more embodiments described herein can be implemented in a local environment only, and/or a non-cloud-integrated distributed environment, for example.

A cloud computing environment can provide one or more of low coupling, modularity and/or semantic interoperability. At the heart of cloud computing is an infrastructure that includes a network of interconnected aspects.

Moreover, the non-limiting system 100 can be associated with and/or be included in cloud-based and/or partially-cloud-based system.

Referring now to details of one or more elements illustrated at FIG. 10, an illustrative cloud computing environment 1000 is depicted. FIG. 10 is a schematic block diagram of a computing environment 1000 with which the disclosed subject matter can interact. The system 1000 comprises one or more remote component(s) 1010. The remote component(s) 1010 can be hardware and/or software (e.g., threads, processes, computing devices). In some embodiments, remote component(s) 1010 can be a distributed computer system, connected to a local automatic scaling component and/or programs that use the resources of a distributed computer system, via communication framework 1040. Communication framework 1040 can comprise wired network devices, wireless network devices, mobile devices, wearable devices, radio access network devices, gateway devices, femtocell devices, servers, etc.

The system 1000 also comprises one or more local component(s) 1020. The local component(s) 1020 can be hardware and/or software (e.g., threads, processes, computing devices). In some embodiments, local component(s) 1020 can comprise an automatic scaling component and/or programs that communicate/use the remote resources 1010 and 1020, etc., connected to a remotely located distributed computing system via communication framework 1040.

One possible communication between a remote component(s) 1010 and a local component(s) 1020 can be in the form of a data packet adapted to be transmitted between two or more computer processes. Another possible communication between a remote component(s) 1010 and a local component(s) 1020 can be in the form of circuit-switched data adapted to be transmitted between two or more computer processes in radio time slots. The system 1000 comprises a communication framework 1040 that can be employed to facilitate communications between the remote component(s) 1010 and the local component(s) 1020, and can comprise an air interface, e.g., Uu interface of a UMTS network, via a long-term evolution (LTE) network, etc. Remote component(s) 1010 can be operably connected to one or more remote data store(s) 1050, such as a hard drive, solid state drive, SIM card, device memory, etc., that can be employed to store information on the remote component(s) 1010 side of communication framework 1040. Similarly, local component(s) 1020 can be operably connected to one or more local data store(s) 1030, that can be employed to store information on the local component(s) 1020 side of communication framework 1040.

The embodiments described herein can be directed to one or more of a system, a method, an apparatus, and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device, and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA), and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented in combination with one or more other program modules. Generally, program modules include routines, programs, components, data structures, and/or the like that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), microprocessor-based or programmable consumer and/or industrial electronics and/or the like. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular based transistors, switches and/or gates, in order to optimize space usage and/or to enhance performance of related equipment. A processor can be implemented as a combination of computing processing units.

Herein, terms such as “store,” “storage,” “data store,” “data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, and/or nonvolatile random access memory (RAM) (e.g., ferroelectric RAM (FeRAM)). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes”, “has”, “possesses”, and the like are used in the detailed description, claims, appendices and/or drawings such terms are intended to be inclusive in a manner similar to the term “comprising” as “comprising” is interpreted when employed as a transitional word in a claim.

The descriptions of the one or more embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

Further aspects of various embodiments described herein are provided by the subject matter of the following clauses:
CLAUSE 1: A system, comprising: a memory that stores computer executable components; and a processor that executes the computer executable components stored in the memory, wherein the computer executable components comprise: a data collection component that collects location data, tire requirements data and tire characterization data for a vehicle; and a data analysis component that determines, by analyzing the location data and the tire requirements data against the tire characterization data, whether one or more tires of the vehicle are to be changed.
CLAUSE 2: The system of any preceding clause, wherein the data analysis component employs a first artificial intelligence (AI) model to perform the analyzing, and wherein the data analysis component further determines, based on the analyzing, whether the one or more tires are safe for regular operations of the vehicle and whether the one or more tires comply with regional regulations associated with a current geographic location of the vehicle and future geographic locations that the vehicle is expected to be driven to.
CLAUSE 3: The system of any preceding clause, wherein the data analysis component further determines a risk associated with upcoming weather by analyzing, via a second AI model, historical data associated with the vehicle and the location data.
CLAUSE 4: The system of any preceding clause, further comprising: an alert component that generates, based on a determination that the one or more tires of the vehicle are to be changed, an alert to an operator of the vehicle, wherein the alert indicates a recommended time period within which the one or more tires are to be changed.
CLAUSE 5: The system of any preceding clause, further comprising: a scheduling component that schedules, based on a determination that the one or more tires of the vehicle are to be changed, a tire change service at an auto shop, wherein scheduling the tire change service comprises: analyzing, by the scheduling component, via a third AI model, preferences of an operator of the vehicle and a list of auto shops accessible by the vehicle.
CLAUSE 6: The system of any preceding clause, wherein the location data comprises information about the current geographic location of the vehicle, the future geographic locations that the vehicle is expected to be driven to, a current date, data from news channels and environmental information comprising weather conditions at the current geographic location of the vehicle and forecasted weather conditions at the future geographic locations that the vehicle is expected to be driven to.
CLAUSE 7: The system of any preceding clause, wherein the tire requirements data comprises information about the regional regulations associated with the current geographic location of the vehicle and the future geographic locations that the vehicle is expected to be driven to.
CLAUSE 8: The system of any preceding clause, wherein the tire characterization data comprises information about mechanical specifications of tires of the vehicle.
CLAUSE 9: The system of any preceding clause, wherein the data collection component collects the location data, the tire requirements data and the tire characterization data via a set of sensors employed by the vehicle and databases accessible to the data collection component.
CLAUSE 10: The system of any preceding clause, further comprising: a training component that periodically trains the first AI model to perform the analyzing, wherein training the first AI model comprises: aggregating, by the training component, performance data and feedback data associated with performance of the data analysis component over a defined duration of time; generating, by the training component, a training dataset based on the aggregating; and updating, by the training component, parameters of the first AI model based on the training dataset.
CLAUSE 11: A computer-implemented method, comprising: collecting, by a system operatively coupled to a processor, location data, tire requirements data and tire characterization data for a vehicle; and determining, by the system, by analyzing the location data and the tire requirements data against the tire characterization data, whether one or more tires of the vehicle are to be changed.
CLAUSE 12: The computer-implemented method of any preceding clause, wherein the analyzing is performed by employing a first AI model, and wherein the computer-implemented method further comprises: determining, by the system, based on the analyzing, whether the one or more tires are safe for regular operations of the vehicle and whether the one or more tires comply with regional regulations associated with a current geographic location of the vehicle and future geographic locations that the vehicle is expected to be driven to.
CLAUSE 13: The computer-implemented method of any preceding clause, further comprising: determining, by the system, a risk associated with upcoming weather by analyzing, via a second AI model, historical data associated with the vehicle and the location data.
CLAUSE 14: The computer-implemented method of any preceding clause, further comprising: generating, by the system, based on a determination that the one or more tires of the vehicle are to be changed, an alert to an operator of the vehicle, wherein the alert indicates a recommended time period within which the one or more tires are to be changed.
CLAUSE 15: The computer-implemented method of any preceding clause, further comprising: scheduling, by the system, based on a determination that the one or more tires of the vehicle are to be changed, a tire change service at an auto shop, wherein the scheduling comprises: analyzing, by the system, via a third AI model, preferences of an operator of the vehicle and a list of auto shops accessible by the vehicle.
CLAUSE 16: The computer-implemented method of any preceding clause, wherein the location data comprises information about the current geographic location of the vehicle, the future geographic locations that the vehicle is expected to be driven to, a current date, data from news channels and environmental information comprising weather conditions at the current geographic location of the vehicle and forecasted weather conditions at the future geographic locations that the vehicle is expected to be driven to.
CLAUSE 17: The computer-implemented method of any preceding clause, wherein the tire requirements data comprises information about the regional regulations associated with the current geographic location of the vehicle and the future geographic locations that the vehicle is expected to be driven to.
CLAUSE 18: The computer-implemented method of any preceding clause, wherein the tire characterization data comprises information about mechanical specifications of tires of the vehicle.
CLAUSE 19: The computer-implemented method of any preceding clause, further comprising: collecting, by the system, the location data, the tire requirements data and the tire characterization data via a set of sensors employed by the vehicle and databases accessible to the vehicle.
CLAUSE 20: A computer program product comprising a computer readable storage medium having program instructions embodied therewith, the program instructions executable by a processor to cause the processor to: collect, by the processor, location data, tire requirements data and tire characterization data for a vehicle; and determine, by the processor, by analyzing the location data and the tire requirements data against the tire characterization data, whether one or more tires of the vehicle are to be changed.

The system of clause 1 above with any set of combinations of clauses 2-10 above.

The computer-implemented method of clause 11 above with any set of combinations of clauses 12-19 above.

What is claimed is:

1. A system, comprising:
a memory that stores computer executable components; and
a processor that executes the computer executable components stored in the memory, wherein the computer executable components comprise:
a data collection component that collects location data, tire requirements data and tire characterization data for a vehicle; and
a data analysis component that determines, by analyzing the location data and the tire requirements data against the tire characterization data, whether one or more tires of the vehicle are to be changed.

2. The system of claim 1, wherein the data analysis component employs a first artificial intelligence (AI) model to perform the analyzing, and wherein the data analysis component further determines, based on the analyzing, whether the one or more tires are safe for regular operations of the vehicle and whether the one or more tires comply with regional regulations associated with a current geographic location of the vehicle and future geographic locations that the vehicle is expected to be driven to.

3. The system of claim 1, wherein the data analysis component further determines a risk associated with upcoming weather by analyzing, via a second AI model, historical data associated with the vehicle and the location data.

4. The system of claim 1, further comprising:
an alert component that generates, based on a determination that the one or more tires of the vehicle are to be changed, an alert to an operator of the vehicle, wherein the alert indicates a recommended time period within which the one or more tires are to be changed.

5. The system of claim 1, further comprising:
a scheduling component that schedules, based on a determination that the one or more tires of the vehicle are to be changed, a tire change service at an auto shop, wherein scheduling the tire change service comprises:
analyzing, by the scheduling component, via a third AI model, preferences of an operator of the vehicle and a list of auto shops accessible by the vehicle.

6. The system of claim 2, wherein the location data comprises information about the current geographic location of the vehicle, the future geographic locations that the vehicle is expected to be driven to, a current date, data from news channels and environmental information comprising weather conditions at the current geographic location of the vehicle and forecasted weather conditions at the future geographic locations that the vehicle is expected to be driven to.

7. The system of claim 2, wherein the tire requirements data comprises information about the regional regulations associated with the current geographic location of the vehicle and the future geographic locations that the vehicle is expected to be driven to.

8. The system of claim 1, wherein the tire characterization data comprises information about mechanical specifications of tires of the vehicle.

9. The system of claim 1, wherein the data collection component collects the location data, the tire requirements data and the tire characterization data via a set of sensors employed by the vehicle and databases accessible to the data collection component.

10. The system of claim 2, further comprising:
a training component that periodically trains the first AI model to perform the analyzing, wherein training the first AI model comprises:
aggregating, by the training component, performance data and feedback data associated with performance of the data analysis component over a defined duration of time;
generating, by the training component, a training dataset based on the aggregating; and
updating, by the training component, parameters of the first AI model based on the training dataset.

11. A computer-implemented method, comprising:
collecting, by a system operatively coupled to a processor, location data, tire requirements data and tire characterization data for a vehicle; and
determining, by the system, by analyzing the location data and the tire requirements data against the tire characterization data, whether one or more tires of the vehicle are to be changed.

12. The computer-implemented method of claim 11, wherein the analyzing is performed by employing a first AI model, and wherein the computer-implemented method further comprises:
determining, by the system, based on the analyzing, whether the one or more tires are safe for regular operations of the vehicle and whether the one or more tires comply with regional regulations associated with a current geographic location of the vehicle and future geographic locations that the vehicle is expected to be driven to.

13. The computer-implemented method of claim 11, further comprising:
determining, by the system, a risk associated with upcoming weather by analyzing, via a second AI model, historical data associated with the vehicle and the location data.

14. The computer-implemented method of claim 11, further comprising:
generating, by the system, based on a determination that the one or more tires of the vehicle are to be changed, an alert to an operator of the vehicle, wherein the alert indicates a recommended time period within which the one or more tires are to be changed.

15. The computer-implemented method of claim 11, further comprising:
scheduling, by the system, based on a determination that the one or more tires of the vehicle are to be changed, a tire change service at an auto shop, wherein the scheduling comprises:
analyzing, by the system, via a third AI model, preferences of an operator of the vehicle and a list of auto shops accessible by the vehicle.

16. The computer-implemented method of claim 12, wherein the location data comprises information about the current geographic location of the vehicle, the future geographic locations that the vehicle is expected to be driven to, a current date, data from news channels and environmental information comprising weather conditions at the current geographic location of the vehicle and forecasted weather conditions at the future geographic locations that the vehicle is expected to be driven to.

17. The computer-implemented method of claim 12, wherein the tire requirements data comprises information about the regional regulations associated with the current geographic location of the vehicle and the future geographic locations that the vehicle is expected to be driven to.

18. The computer-implemented method of claim 11, wherein the tire characterization data comprises information about mechanical specifications of tires of the vehicle.

19. The computer-implemented method of claim 11, further comprising:
collecting, by the system, the location data, the tire requirements data and the tire characterization data via a set of sensors employed by the vehicle and databases accessible to the vehicle.

20. A computer program product comprising a computer readable storage medium having program instructions embodied therewith, the program instructions executable by a processor to cause the processor to:
collect, by the processor, location data, tire requirements data and tire characterization data for a vehicle; and
determine, by the processor, by analyzing the location data and the tire requirements data against the tire characterization data, whether one or more tires of the vehicle are to be changed.
